(19) United States
(12) Patent Application Publication
(10) Pub. No.: US 2026/0101268 A1
(43) Pub. Date: Apr. 9, 2026

(54) USER DEVICE MOBILITY TRIGGERED CORE NETWORK SELECTION

(71) Applicant: T-MOBILE INNOVATIONS LLC, Overland Park, KS (US)

(72) Inventors: Zheng FANG, McLean, VA (US); Yu WANG, Fairfax, VA (US)

(21) Appl. No.: 18/905,858

(22) Filed: Oct. 3, 2024

(51) Int. Cl. H04W 48/04; H04W 48/18

(52) U.S. Cl. CPC H04W 48/04; H04W 48/18

(57) ABSTRACT

Systems and methods for selecting a core network for a connection to a user device are provided. A velocity of the user device and/or a mobility status of the user device is determined. Location data indicative of a location of a user device may also be received. A first core network or a second core network is selected for a connection to the user device based on the location of the user device, the velocity of the user device, and/or the mobility status of the user device.

### SUMMARY

The present disclosure is directed, in part, to core network selection for a connection to a user device substantially as shown in and/or described in connection with at least one of the figures, and as set forth more completely in the claims.

A high-level overview of various aspects of the present technology is provided in this section to introduce a selection of concepts in a simplified form that are further described below in the detailed description. This summary is not intended to identify key features or essential features of the claimed subject matter, nor is it intended to be used in isolation as an aid in determining the scope of the claimed subject matter.

In aspects set forth herein, and at a high level, the technology described herein relates to facilitating core network selection for a connection to a user device based, at least in part, on a velocity, mobility status, and/or location of the user device. While user devices are typically statically allocated to a single core network, aspects herein provide for selecting among multiple core networks (e.g., that are operated by the same network operator) and switching between the multiple core networks based on a velocity, mobility status, and/or location of the user device. The techniques described herein provide flexible options for the network operator operating the multiple core networks and may lead to better service quality for more user devices connected to the multiple core networks.

### BRIEF DESCRIPTION OF THE DRAWINGS

Aspects of the present disclosure are described in detail herein with reference to the attached Figures, which are intended to be exemplary and non-limiting, wherein:

FIG. 1 is a diagram illustrating an example network environment for use in accordance with aspects herein;

FIG. 2 is flow chart illustrating an example method for core network selection, in accordance with aspects herein;

FIG. 3 is flow chart illustrating another example method for core network selection, in accordance with aspects herein;

FIG. 4 is flow chart illustrating another example method for core network selection, in accordance with aspects herein;

FIG. 5 is a flow chart illustrating another method for core network selection, in accordance with aspects herein; and

FIG. 6 is a diagram illustrating an example computing environment, in accordance with aspects herein.

### DETAILED DESCRIPTION

The subject matter of embodiments of the present disclosure is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

By way of background, mobile network operators (MNOs) typically utilize a single core network and may utilize dedicated radio access network (RAN) resources (e.g., a base station) or shared RAN resources for implementation of a telecommunications network. When using a single core network and dedicated RAN resources, core network selection is not needed. When sharing RAN resources (e.g., using a Multi-Operator Core Network (MOCN) architecture), a shared base station may be connected to core networks that are operated by different MNOs, and the base station may select which core network to service a particular user device based on the public land mobile networks (PLMNs) configured for the base station, which may be public PLMNs or private PLMNs, and the associated core network.

Conventionally, when using a single core network, a single MNO need not implement core network selection for a connection to user devices. For MNOs that operate multiple core networks, user devices are statically assigned to core networks that support a particular level of core signaling overhead depending on the type of device (e.g., mobile device or stationary device). For example, a smartphone may be allocated to the core network that supports a higher level of core signaling overhead whereas a desktop computing device may be allocated to the core network that supports a lower level of core signaling overhead signaling. However, it is often the case that a smartphone is stationary for long periods of time (e.g., while the user is at home or work), so the higher levels of core signaling overhead are not always needed to support operation of the smartphone.

Unlike conventional solutions, the present disclosure is directed to selecting a first core network or a second core network for a connection to a user device based on a velocity of the user device, a mobility status of the user device, and/or a location of the user device at a given time. The velocity, mobility status, and/or location of the user device may be determined based on data provided by the user device itself or provided by one or more other components of the telecommunications network. The core network used for the connection to the user device may also be selected or switched based on a loading condition for at least one of the core networks. By selecting the first core network or the second core network for a connection to a user device based on the different factors as discussed herein, an MNO operating the core networks may more efficiently and cost-effectively provide core network resources for user devices.

In one aspect, a method is provided for core network selection. The method includes receiving data indicative of a velocity of a user device. The method also includes comparing the velocity of the user device to a first threshold. Further, the method includes selecting a first core network for a connection to the user device based on whether the velocity of the user device exceeds the first threshold.

In another aspect, a system for core network selection is provided. The system includes one or more processors and one or more computer-readable media storing computer-usable instructions that, when executed by the one or more processors, cause the one or more processors to perform a method. The method includes determining a velocity of a user device and/or a mobility status of the user device. The method also includes selecting a first core network or a second core network for a connection to the user device based on the velocity of the user device and/or the mobility status of the user device.

In yet another aspect, a method is provided for core network selection. The method includes receiving location data indicative of a location of a user device. The method also includes determining a velocity of the user device and/or a mobility status of the user device. Further, the method includes selecting a first core network or a second core network for a connection to the user device based on the location of the user device, the velocity of the user device and/or the mobility status of the user device.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022).

As used herein, the term “base station” (used for providing UEs with access to the telecommunication services) or “node” generally refers to one or more base stations, nodes, RRUs control components, and the like (configured to provide a wireless interface between a wired network and a wirelessly connected user device). A base station may comprise one or more nodes (e.g., eNB, gNB, and the like) that are configured to communicate with user devices. In some aspects, the base station may include one or more band pass filters, radios, antenna arrays, power amplifiers, transmitters/receivers, digital signal processors, control electronics, GPS equipment, and the like.

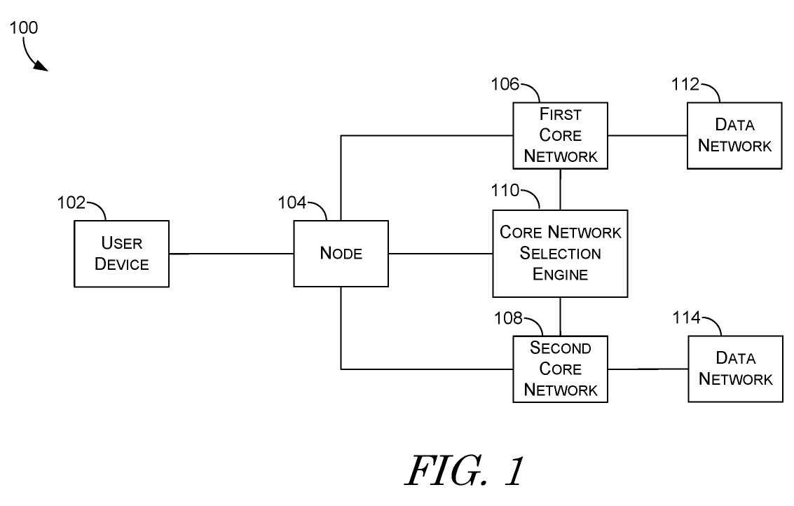

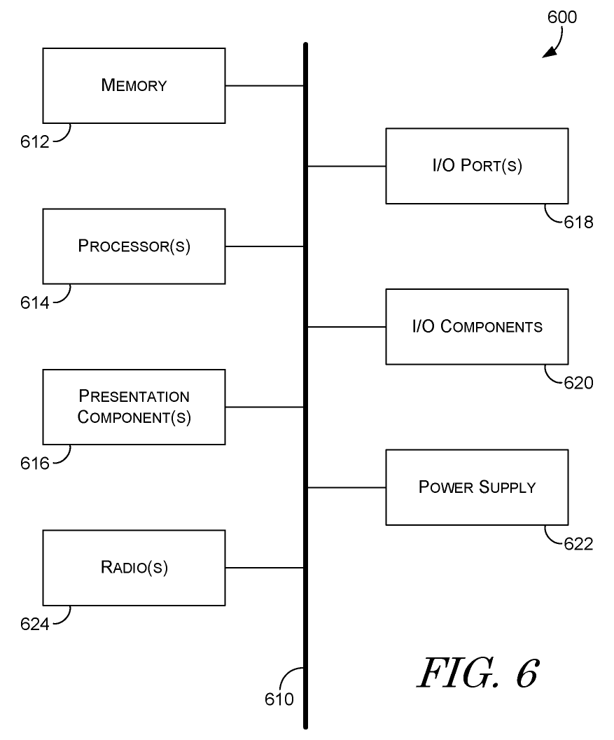

Additionally, a “user device,” as used herein, is a device that has the capability of using a wireless communications network, and may also be referred to as a “computing device,” “mobile device,” “user equipment,” “wireless communication device,” “device,” or “UE.” A user device, in some aspects, may take on a variety of forms, such as a PC, a laptop computer, a tablet, a mobile phone, a PDA, a server, or any other device that is capable of communicating with other devices (e.g., by transmitting or receiving a signal) using a wireless communication. A user device may be, in an embodiment, similar to the user device 102 described herein with respect to FIG. 1. A user device may also be, in another embodiment, similar to the computing device 600, described herein with respect to FIG. 6.

A user device may additionally include internet-of-things devices, such as one or more of the following: a sensor, controller (e.g., a lighting controller, a thermostat), appliances (e.g., a smart refrigerator, a smart air conditioner, a smart alarm system), other internet-of-things devices, or one or more combinations thereof. Internet-of-things devices may be stationary, mobile, or both. In some aspects, the user device is associated with a vehicle (e.g., a video system in a car capable of receiving media content stored by a media device in a house when coupled to the media device via a local area network). In some aspects, the user device comprises a medical device, a location monitor, a clock, other wireless communication devices, or one or more combinations thereof.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions – including data structures and program modules – in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

Turning to FIG. 1, FIG. 1 is a diagram illustrating an example network environment 100 in which aspects of selecting a core network may be implemented. Such a network environment is illustrated and designated generally as network environment 100. Network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

As shown in FIG. 1, network environment 100 comprises a user device 102, a node 104, a first core network 106, a second core network 108, a core network selection engine 110, a first data network 112, and a second data network 114. In the example shown in FIG. 1, the first core network 106 and the second core network 108 are operated by the same mobile network operator (MNO).

The user device 102 may include any device employed by an end-user to communicate with a telecommunications network, such as a wireless telecommunications network. The user device 102 may, in general, comprise forms of equipment and machines such as but, not limited to, Internet-of-Things (IoT) devices and smart appliances, autonomous or semi-autonomous vehicles including cars, trucks, trains, aircraft, urban air mobility (UAM) vehicles and/or drones, industrial machinery, robotic devices, exoskeletons, manufacturing tooling, thermostats, locks, smart speakers, lighting devices, smart receptacles, controllers, mechanical actuators, remote sensors, weather or other environmental sensors, wireless beacons, cash registers, turnstiles, security gates, or any other smart device. That said, in some embodiments, the user device 102 may include computing devices such as, but not limited to, handheld personal computing devices, cellular phones, smartphones, tablets, laptops, and similar consumer equipment, or stationary desktop computing devices, workstations, servers and/or network infrastructure equipment. As such, the user device 102 may be a mobile UE or a stationary UE. The user device 102 may include one or more processors, and one or more non-transient computer-readable media for executing code to carry out the functions of the user device 102 described herein. The computer-readable media may include computer-readable instructions executable by the one or more processors. In some embodiments, the user device 102 may be implemented using a computing device 600 as discussed below with respect to FIG. 6.

Nodes, such as the node 104, are often individually referred to as a radio access network (RAN) and/or a wireless communication base station system. In the embodiment shown in FIG. 1, the node 104 may function as an access node via which the user device 102 within coverage area of the node 104 can wirelessly access services of the first core network 106 and the second core network 108, such as telecommunications and data connectivity.

In the context of fourth generation (4G) Long Term Evolution (LTE), the node 104 may be referred to as an eNodeB, or eNB. In the context of fifth generation (5G) New Radio (NR), the node 104 may be referred to as a gNodeB, or gNB. Nodes may be terrestrial or extraterrestrial. Other terminology may also be used depending on the specific implementation technology. As such, in some embodiments, the network environment 100 comprises, at least in part, a wireless communications network, such as the first core network 106 and the second core network 108. The first core network 106 and the second core network 108 communicate with the core network selection engine 110. Further, the first core network 106 and the second core network 108 also communicate with the data network 112 and the data network 114, respectively.

In some embodiments, the node 104 may comprise a multi-modal network (for example comprising one or more multi-modal access devices) where multiple radios supporting different systems are integrated into the radio of the node 104. Such a multi-modal RAN may support a combination of 3GPP radio technologies (e.g., 4G, 5G and/or 6G) and/or non-3GPP radio technologies.

The first core network 106 may be a component of a wireless communications network that provides one or more wireless network services to one or more devices (e.g., user device 102) within the coverage areas of a plurality of nodes, including the node 104. In particular, first core network 106 provides combinations of network services to the user device 102 for one or more first public land mobile networks (PLMNs) that the user device 102 may attach to via channels of one or more RF bands (referred to herein as RF band layers). The first core network 106 may be designed and deployed to handle stationary or low mobility devices and may be implemented with networking equipment that is purchased by the network operator and operated according to a service agreement that does not scale based on a number of subscribers (users) that connect to the first core network 106. The first core network 106 may also be configured to support standalone 5G operation.

The second core network 108 may be a component of a wireless communications network that provides one or more wireless network services to one or more devices (e.g., user device 102) within the coverage areas of a plurality of nodes, including the node 104. In particular, the second core network 108 provides combinations of network services to the user device 102 for one or more second PLMNs that the user device 102 may attach to via RF band layers. The second PLMN(s) for the second core network 108 are different from the first PLMN(s) for the first core network 106. The second core network 108 may be implemented with networking equipment in a data center that is rented or leased by the network operator and costs are based on a number of subscribers (users) that connect to the second core network 108. Further, the second core network 108 may be designed and deployed to handle user devices with higher rates of mobility compared to the first core network 106. Accordingly, the processing power of the network function nodes of the second core network 108 may generally be greater than the processing power of the network functions nodes of the first core network 106 in order to handle a greater amount of core signaling overhead typically needed for high mobility devices. The second core network 108 may also be configured to support non-standalone 5G operation and LTE operation.

The user device 102 may be a multi-PDN (Packet Data Network) capable device that uses multiple Access Point Names (APNs). The user device 102 may be able to switch between the PDNs or may also use concurrent PDN operation. In some embodiments, multiple PLMNs (e.g., at least some of the first PLMNs and the second PLMNs) are pushed to the user device 102 (e.g., using one or more Equivalent PLMNs (EPLMNs) or Equivalent Home PLMNs (EHPLMNs)) by the wireless communications network, which indicates that there are multiple PLMNs that the user device 102 may try for attachment.

The network environment 100 is generally configured for wirelessly connecting the user device 102 to other devices via node 104, via other RAN and/or other local wireless cellular access points, and/or via other telecommunication networks or a publicly-switched telecommunication network (PSTN), for example. The network environment 100 may be generally configured, in some embodiments, for wirelessly connecting the user device 102 to data or services that may be accessible on one or more application servers or other functions, nodes, or servers (such as services provided by servers of the data network 112 or the data network 114, for example). The data network 112 and the data network 114, in aspects, may be private data networks or a public data networks (e.g., the Internet).

The core network selection engine 110 may be a separate component or may be incorporated, at least in part, into the first core network 106 and/or the second core network 108. The core network selection engine 110 may select either the first core network 106 or the second core network 108 for a connection to the user device 102 based on a velocity, mobility status, and/or or location of the user device 102. The core network selection engine 110 may obtain data indicative of (or determine) the velocity, mobility status, and/or location of the user device 102 from the user device 102 itself, the node 104, the first core network 106, and/ or the second core network 108. In some embodiments, the core network selection engine 110 may select the first core network 106 for the connection to the user device 102 if the user device 102 is traveling at a low velocity, has a low mobility status, and/or is located at a location associated with low mobility (e.g., indoors). Conversely, the core network selection engine 110 may select the second core network 108 for the connection to the user device 102 if the user device 102 is traveling at a relatively high velocity, has a relatively high mobility status, and/or is located at a location associated with high mobility (e.g., outdoors).

Once an initial selection is made for the connection to the user device 102, the core network selection engine 110 may continue to the monitor the velocity, mobility status, and/or location of the user device 102 and switch the selection of the core network in response to a change in the velocity, mobility status, and/or location of the user device 102. The circumstances where switching the connection to the user device 102 in response to a change are discussed further herein. Switching the core network in response to a change in the velocity, mobility status, and/or location of the user device 102 may include a core network triggered handover.

In some embodiments, the core network selection engine 110 may also receive data indicative of a loading condition of the first core network 106 and utilize this data when determining whether to select or switch the core network for the connection to the user device 102. For example, the core network selection engine 110 may select the second core network 108 for a connection to the user device 102, or switch the connection to the user device 102 from the first core network 106 to the second core network 108, in response to the loading condition of the first core network 106 being above a threshold.

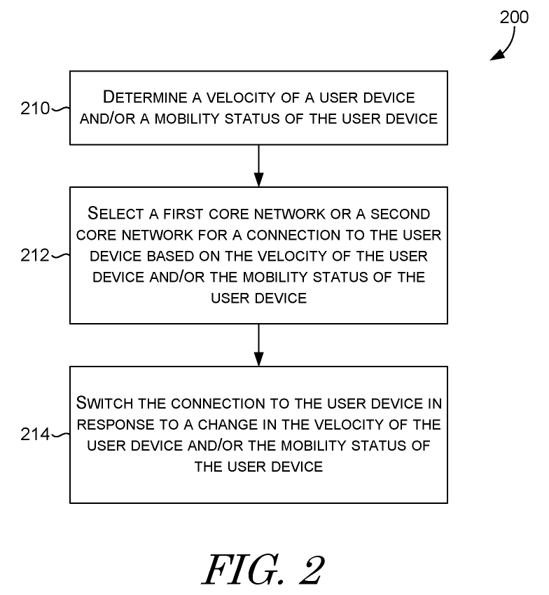

FIG. 2 is a flow chart illustrating an example method 200 for core network selection, in accordance with some embodiments of the present disclosure. It should be understood that the features and elements described herein with respect to the method 200 of FIG. 2 may be used in conjunction with, in combination with, or substituted for elements of, any of the other embodiments discussed herein and vice versa. Further, it should be understood that the functions, structures, and other descriptions of elements for embodiments described in FIG. 2 may apply to like or similarly named or described elements across any of the figures and/or embodiments described herein and vice versa.

At block 210, a velocity of a user device and/or a mobility status of the user device is determined. The velocity of the user device and/or the mobility status of the user device may be determined by the user device itself or may be determined by a different component (e.g., the core network selection engine 110 or a component of the core network(s)).

The velocity of the user device may indicate an estimated speed of the user device. The velocity of the user device may be determined based on data indicative of the velocity of the user device provided by the user device to one or more elements of core network(s). The data indicative of velocity may include, but is not limited to, velocity data (e.g. velocity of the user device determined by the user device), location data (e.g., GNSS, Bluetooth, or Wi-Fi based location data), accelerometer data, or combinations thereof. The velocity of the user device may also be determined based on data indicative of velocity of the user device provided by a node (e.g., the node 104 described with respect to FIG. 1) or one or more components of the core network(s).

The mobility status of the user device may indicate a level of handover or redirection activity for the user device. The mobility status of the user device may be determined based on data indicative of mobility, which may include, but is not limited to, a number of handovers for the user device over a period of time, a number of redirections for the user device over the period of time, a level of mobility corresponding to number of handovers and/or redirections for the user device over the period of time, or combinations thereof. The data indicative of mobility may be provided by the user device itself, a node, or one or more components of the core network(s).

At block 212, a first core network or a second core network is selected for a connection to the user device based on the velocity of the user device and/or the mobility status of the user device. In some embodiments, if the velocity of the user device is above a certain threshold and/or the mobility status of the user device indicates high mobility, then the second core network (e.g., the second core network 108 described with respect to FIG. 1) may be selected. Otherwise, the first core network (e.g., the first core network 106 described with respect to FIG. 1) may be selected.

At block 214, the connection to the user device is switched in response to a change in the velocity of the user device and/or the mobility status of the user device. The velocity of the user device and/or the mobility status may be determined after the initial selection of the core network in a manner similar to that described with respect to block 210. If there is a change in the velocity of the user device or the mobility status of the user device, the connection to the user device may be switched in response to the change. For example, if the velocity of the user device increases significantly or the mobility status of the user device indicates high mobility after the first core network is selected for the connection to the user device, then the connection to the user device may be switched to the second core network. As discussed above, the second core network may be better equipped to handle a greater amount of core signaling overhead typically needed for high mobility devices.

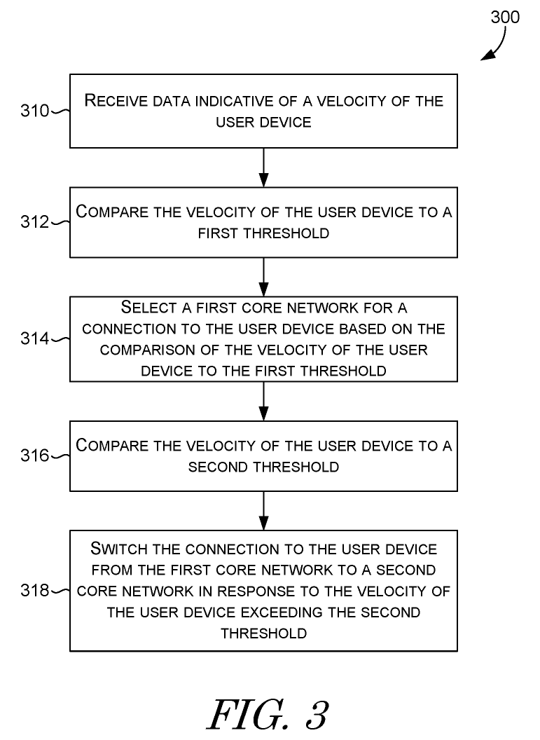

Turning now to FIG. 3, another example method 300 is provided for core network selection, in accordance with some embodiments of the present disclosure. It should be understood that the features and elements described herein with respect to the method 300 of FIG. 3 may be used in conjunction with, in combination with, or substituted for elements of, any of the other embodiments discussed herein and vice versa. Further, it should be understood that the functions, structures, and other descriptions of elements for embodiments described in FIG. 3 may apply to like or similarly named or described elements across any of the figures and/or embodiments described herein and vice versa.

At block 310, data indicative of a velocity of the user device is received. The data indicative of velocity of the user device may include, but is not limited to, velocity data (e.g. velocity of the user device determined by the user device), location data (e.g., GNSS, Bluetooth, or Wi-Fi based location data), accelerometer data, or combinations thereof. The data indicative of velocity of the user device may be provided by the user device itself, a node (e.g., the node 104 described with respect to FIG. 1), or one or more components of the core network(s).

At block 312, the velocity of the user device is compared to a first threshold. The first threshold may indicate an upper limit for a “low velocity” user device that can utilize the first core network (e.g., the first core network 106). The first threshold may be selected, at least partially, based on a device type of the user device. In other words, the first threshold may be different depending on the device type of the user device. The first threshold may be a static, predetermined threshold. As a non-limiting example, the first threshold may be set to walking speed (e.g., approximately 5 mph). In some embodiments, the first threshold may be adapted based on the location of the user device, a device type of user device, a time of day, a schedule, and the like. The adaptation of the first threshold may be implemented using one or more machine learning models trained to predict an appropriate first threshold based on correlations between velocity (and other factors listed above) and an amount of handover events, increased signaling, and the like.

At block 314, the first core network is selected for a connection to the user device based on the comparison of the velocity of the user device to the first threshold. The first core network may be selected in response to the velocity of the user device being below (or equal to) the first threshold.

At block 316, the velocity of the user device is compared to a second threshold. The second threshold is greater than the first threshold and separated by a buffer range to provide hysteresis and prevent a high rate of switching. The second threshold may indicate a lower limit for a “high velocity” user device that would be better served by the second core network (e.g., the second core network 108). The second threshold may be selected, at least partially, based on a device type of the user device. In other words, the second threshold may be different depending on the device type of the user device. The second threshold may be a static, predetermined threshold. As a non-limiting example, the second threshold may be set to a speed that is higher than the first threshold (e.g., approximately 10 mph). In some embodiments, the second threshold may be adapted based on the location of the user device, a device type of user device, a time of day, and/or a schedule. The adaptation of the second threshold may be implemented using using one or more machine learning models trained to predict an appropriate second threshold based on correlations between velocity (and other factors listed above) and an amount of handover events, increased signaling, and the like.

At block 318, the connection to the user device is switched from the first core network to the second core network in response to the velocity of the user device exceeding the second threshold. Switching from the first core network to the second core network may include a core network triggered handover.

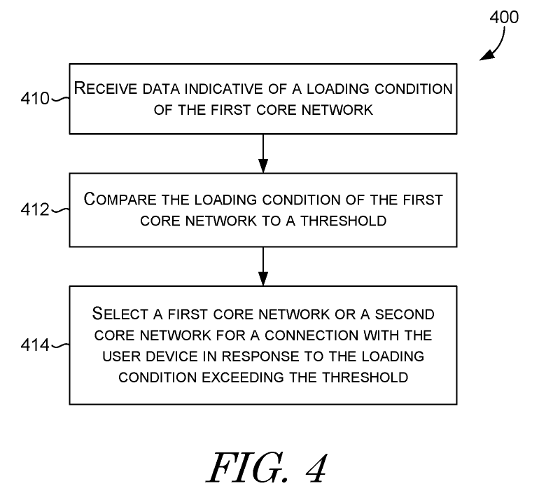

Referring to FIG. 4, another example method 400 is provided for core network selection, in accordance with some embodiments of the present disclosure. It should be understood that the features and elements described herein with respect to the method 400 of FIG. 4 may be used in conjunction with, in combination with, or substituted for elements of, any of the other embodiments discussed herein and vice versa. Further, it should be understood that the functions, structures, and other descriptions of elements for embodiments described in FIG. 2 may apply to like or similarly named or described elements across any of the figures and/or embodiments described herein and vice versa.

At block 410, data indicative of a loading condition of the first core network is received. The data indicative of the loading condition of the first core network may include a number of connected user devices, a percentage of resources utilized, and the like for the first core network. The data indicative of the loading condition of the first core network may be provided by a node (e.g., a base station) or one or more components of the first core network.

At block 412, the loading condition of the first core network is compared to a threshold. The threshold may be selected based on a level of loading (congestion) that is correlated with a guaranteed level of service or other factors associated with user experience for the connected user devices. The threshold may indicate an upper limit for the loading condition with a buffer where the first core network can still meet guaranteed levels of services for connected user devices. The threshold may be selected, at least partially, based on a number of users, types of users, traffic patterns, and the like. The threshold may be a static, predetermined threshold. As a non-limiting example, the may be set to a particular number of users or a particular percentage of resources utilized. In some embodiments, the threshold may be adapted based on the location of the user device, a time of day, and/or a schedule. The adaptation of the second threshold may be implemented using one or more machine learning models trained to predict an appropriate threshold based on correlations between the loading condition of the first core network and a location of the user device, a time of day, a schedule, and the like.

At block 414, a second core network is selected for the connection to the user device in response to the loading condition of the first core network exceeding the threshold. The second core network may be initially selected for the user device if the loading condition of the first core network exceeds the threshold when the user device is initially connecting to a core network. If the user device is connected to the first core network and the loading condition of the first core network exceeds the threshold, then the connection to the user device may be switched from the first core network to the second core network (e.g., using a core network triggered handover).

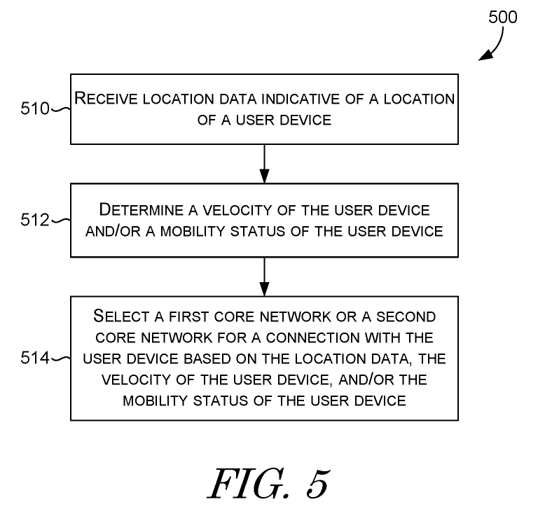

Referring to FIG. 5, another example method 500 is provided for core network selection, in accordance with some embodiments of the present disclosure. It should be understood that the features and elements described herein with respect to the method 500 of FIG. 5 may be used in conjunction with, in combination with, or substituted for elements of, any of the other embodiments discussed herein and vice versa. Further, it should be understood that the functions, structures, and other descriptions of elements for embodiments described in FIG. 5 may apply to like or similarly named or described elements across any of the figures and/or embodiments described herein and vice versa.

At block 510, location data indicative of location of the user device is received. The location data may include, but is not limited to, GNSS based location data, Bluetooth based location data, Wi-Fi based location data, triangulation data, angle of arrival measurements, or combinations thereof. The location data may be provided by the user device, the node, or one or more components of the core network(s) (e.g., the network location server). The location data may be the most recently received location data or may include historic location data in addition to, or instead of, the most recently received location data.

In some embodiments, an estimation of whether the user device is indoors or outdoors is determined based, at least in part, on the location of the user device. The estimation may be performed using the location data and other types of data available (e.g., mapping data) to the core network selection engine via one or more data networks. The estimation of whether the user device is indoors or outdoors may also be determined using one or more machine learning models trained to predict whether the user device in indoors or outdoors based on correlations between indoor and outdoor status (e.g., based on mapping data) and historical location data, velocity data, and the like.

At block 512, a velocity of the user device and/or a mobility status of the user device is determined in a manner similar to that described herein with respect to block 210 of FIG. 2.

At block 514, a first core network or a second core network is selected for a connection to the user device based on the location of the user device, the velocity of the user device, and/or the mobility status of the user device. Some locations of the user device may be associated with low mobility (e.g., indoors) and this may be determinative in some instances regardless of the velocity of the user device or the mobility status of the user device. A non-limiting example of a situation where this could arise is when the location of the user device is in an elevator of high-rise building and traveling at a velocity that is greater than a threshold (e.g., the second threshold discussed herein with respect to FIG. 3). Further, if the velocity of the user device and the mobility status of the user device indicate that the user device is “low velocity” or “low mobility” as discussed herein, this may also be determinative even if the user device is outdoors. A non-limiting example of a situation where this could arise is when the location of the user device is at an outdoor field or concert venue.

In some embodiments, the selection of the first core network or the second core network may also be implemented using one or more machine learning models trained to output a core network selection based on correlations between the location data, velocity, and/or mobility status and an amount of handover events, increased signaling, and the like.

Referring to FIG. 6, a diagram is depicted of an exemplary computing environment suitable for use in implementations of the present disclosure. In particular, the exemplary computer environment is shown and designated generally as computing device 600. Computing device 600 is but one example of a suitable computing environment and is not intended to suggest any limitation as to the scope of use or functionality of the embodiments described herein. Neither should computing device 600 be interpreted as having any dependency or requirement relating to any one or combination of components illustrated.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 6, computing device 600 includes bus 610 that directly or indirectly couples one or more of the following devices: memory 612, one or more processors 614, one or more presentation components 616, input/output (I/O) ports 618, I/O components 620, power supply 622, and radio 624. Bus 610 represents what may be one or more busses (such as an address bus, data bus, or combination thereof). The components of FIG. 6 are shown with lines for the sake of clarity. However, it should be understood that the functions performed by one or more components of the computing device 600 may be combined or distributed amongst the various components. For example, a presentation component such as a display device may be one of I/O components 620. In some embodiments, a base station, RAN and/or network server node, implementing one or more aspects of a GNAD manager may comprise a computing device 600. In some embodiments, the user device 102 from FIG. 1 may comprise a computing device such as computing device 600.

The processors of computing device 600, such as one or more processors 614, have memory. The present disclosure hereof recognizes that such is the nature of the art, and reiterates that FIG. 6 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 6 and refer to “computer” or “computing device.”

Computing device 600 typically includes a variety of computer-readable media. Computer-readable media can be any available non-transient media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable non-transient media implemented in any method or technology for storage of information such as computer-readable instructions, data structures, program modules or other data.

Computer storage media includes non-transient RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media and computer-readable media do not comprise a propagated data signal or signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 612 includes tangible, non-transient, computer-storage media in the form of volatile and/or nonvolatile memory. Memory 612 may be removable, non-removable, or a combination thereof. Exemplary memory includes solid-state memory, hard drives, optical-disc drives, etc. Computing device 600 includes one or more processors 614 that read data from various entities such as bus 610, memory 612 or I/O components 620. One or more presentation components 616 may present data indications to a person or other device. Exemplary one or more presentation components 616 include a display device, speaker, printing component, vibrating component, etc. I/O ports 618 allow computing device 600 to be logically coupled to other devices including I/O components 620, some of which may be built in computing device 600. Illustrative I/O components 620 include a microphone, joystick, game pad, satellite dish, scanner, printer, wireless device, etc.

Radio(s) 624 represents a radio that facilitates communication with a wireless telecommunications network. For example, radio(s) 624 may be used to establish communications with a UE and/or a RAN. Illustrative wireless telecommunications technologies include CDMA, GPRS, TDMA, GSM, 4G LTE, 3GPP 5G, 6G, and other 3GPP technologies. Radio(s) 624 may additionally or alternatively facilitate other types of non-3GPP wireless communications including Wi-Fi, WiMAX, and/or other VoIP communications. In some embodiments, radio(s) 624 may support multi-modal connections that include a combination of 3GPP radio technologies (e.g., 4G, 5G and/or 6G) and/or non-3GPP radio technologies. As can be appreciated, in various embodiments, radio(s) 624 can be configured to support multiple technologies and/or multiple radios can be utilized to support multiple technologies. In some embodiments, the radio(s) 624 may support communicating with an access network comprising a terrestrial wireless communications base station and/or a space-based access network (e.g., an access network comprising a space-based wireless communications base station). A wireless telecommunications network might include an array of devices, which are not shown so as to not obscure more relevant aspects of the embodiments described herein. Components such as a base station, a communications tower, or even access points (as well as other components) can provide wireless connectivity in some embodiments.

As used herein, the terms “function”, “unit”, “server”, “node” and “module” are used to describe computer processing components and/or one or more computer executable services being executed on one or more computer processing components. In the context of this disclosure, such terms used in this manner would be understood by one skilled in the art to refer to specific network elements and not used as nonce word or intended to invoke 35 U.S.C. 112(f).

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A method for core network selection, the method comprising:
receiving data indicative of a velocity of a user device;
comparing the velocity of the user device to a first threshold; and
selecting a first core network for a connection to the user device based on whether the velocity of the user device exceeds the first threshold.

2. The method of claim 1, wherein the first threshold is based at least partially on a device type of the user device.

3. The method of claim 1, wherein the first threshold is a predetermined threshold.

4. The method of claim 1, wherein the first threshold is a dynamic threshold that is adapted based on a location of the user device, a device type of the user device, a time of day, and/or a schedule.

5. The method of claim 1, further comprising:
comparing the velocity of the user device to a second threshold that is greater than the first threshold; and
switching the connection to the user device from the first core network to a second core network in response to the velocity of the user device exceeding the second threshold.

6. The method of claim 1, wherein the data indicative of the velocity of the user device is received from the user device.

7. The method of claim 1, further comprising switching the connection to the user device from the first core network to a second core network in response to a loading condition of the first core network exceeding a threshold.

8. A system for core network selection, comprising:
one or more processors; and
one or more computer-readable media storing computer-usable instructions that, when executed by the one or more processors, cause the one or more processors to:
determine a velocity of a user device and/or a mobility status of the user device; and
select a first core network or a second core network for a connection to the user device based on the velocity of the user device and/or the mobility status of the user device.

9. The system of claim 8, wherein the computer-usable instructions, when executed by the one or more processors, further cause the one or more processors to switch the connection to the user device from the first core network to the second core network or from the second core network to the first core network in response to a change in the velocity of the user device and/or the mobility status of the user device.

10. The system of claim 8, wherein selecting the first core network or the second core network for the connection to the user device is further based on a loading condition of the first core network.

11. The system of claim 8, wherein selecting the first core network or the second core network for the connection to the user device is further based on an selection recommendation from a base station, wherein the base station is communicatively coupled the first core network and the second core network.

12. The system of claim 8, wherein selecting the first core network or the second core network for the connection to the user device is further based on a location of the user device and/or a type of device of the user device.

13. The system of claim 8, wherein the system is included at least partially in the user device.

14. The system of claim 8, wherein the system is included at least partially in the first core network and/or the second core network.

15. A method for core network selection, the method comprising:
receiving location data indicative of a location of a user device;
determining a velocity of the user device and/or a mobility status of the user device; and
selecting a first core network or a second core network for a connection to the user device based on the location of the user device, the velocity of the user device, and/or the mobility status of the user device.

16. The method of claim 15, wherein determining the velocity of the user device and/or the mobility status of the user device is based, at least in part, on data from the user device.

17. The method of claim 15, wherein determining the velocity of the user device and/or the mobility status of the user device is based on data stored in the first core network and/or the second core network.

18. The method of claim 15, further comprising determining an estimation of whether the user device is indoors or outdoors based, at least in part, on the location data indicative of the location of the user device.

19. The method of claim 15, further comprising switching the connection to the user device from the first core network to the second core network or from the second core network to the first core network based on a change in the location of the user device, the velocity of the user device, and/or the mobility status of the user device.

20. The method of claim 15, further comprising switching the connection to the user device from the first core network to the second core network or from the second core network to the first core network based on a loading condition of the first core network.
